(19) United States
(12) Patent Application Publication
(10) Pub. No.: US 2012/0219810 A1
(43) Pub. Date: Aug. 30, 2012

(54) REFLECTIVE BARRIER

(76) Inventor: Brian T. Wickhorst, High River (CA)

(21) Appl. No.: 13/405,937

(22) Filed: Feb. 27, 2012

Related U.S. Application Data
(60) Provisional application No. 61/446,723, filed on Feb. 25, 2011.

(51) Int. Cl. B32B 15/08; B32B 37/10; B32B 37/12; B32B 37/06; B32B 37/14; B32B 37/02

(52) U.S. Cl. 428/461; 156/60; 156/151; 156/327

(57) ABSTRACT

Disclosed herein is a flexible composite laminate barrier for placement near the interior of a window to control the passage of heat therethrough. The barrier comprises a first exterior-directed layer, an intermediate layer, and a third interior-directed layer. The first layer comprises a sheet having an exterior-directed surface and an interior-directed surface, and a coating disposed on the exterior-directed surface of the sheet. The intermediate layer comprises a sheet having an exterior-directed surface and an interior-directed surface, and an aluminum layer adhered to the exterior-directed surface of the intermediate layer. The third layer comprises a sheet of similar or same material as that of the first sheet. An adhesive is disposed between both the adjacent layers and the layers are calendered together to form the composite laminate barrier.

### CROSS-REFERENCE TO RELATED APPLICATION

This application claims the benefit of U.S. Provisional Application 61/446,723, which was filed on Feb. 25, 2010, the entire disclosure of which is hereby incorporated by reference.

### BACKGROUND OF THE INVENTION

1. Field of the Invention

The present invention pertains to reflective barriers. More particularly, the present invention pertains to window coverings which include a reflective barrier. Even more particularly, the present invention concerns flexible window shade-like reflective barriers which control the flow of heat therepast.

2. Prior Art

Windows and similar building openings are notorious as sources of heat loss and heat gain. Thus, the art has directed efforts to minimize these solar heat losses and gains. To this end, there has been developed many types of window coverings which are not only decorative, but which are also intended to act as thermal insulators which either reduce the infiltration of cold from the exterior into the interior of a space, or as a radiant barrier which prevents heat from escaping the interior of the structure.

Examples of these types of barriers are disclosed in U.S. Pat. No. 6,289,968 to Karten et al.; U.S. Pat. No. 5,184,659 to Alcocer; U.S. Pat. No. 4,416,096 to Schuster et al.; U.S. Pat. No. 4,397,346 to Chumbley et al.; U.S. Pat. No. 4,344,473 to Shore; U.S. Pat. No. 4,307,768 to Anderson; U.S. Pat. No. 4,158,718 to Kehl et al.; U.S. Pat. No. 4,079,772 to Klaenhammer et al.; and United States Application Publication No. 2008/01 91 51 1 to Neuer et al.

While the prior art is efficacious, there still exists a need for improved barriers which address the issues of solar heat and the movement of radiant energy through such barriers. As detailed below, the present invention addresses this issue.

### SUMMARY OF THE INVENTION

According an embodiment hereof, there is provided a flexible composite laminate barrier for placement near the interior of a window to control the passage of heat therethrough. The barrier comprises a first exterior-directed layer, an intermediate layer, and a third interior-directed layer.

The first layer comprises a sheet having an exterior-directed surface and an interior-directed surface, and a coating disposed on the exterior-directed surface of the sheet.

The intermediate layer comprises a sheet having an exterior-directed surface and an interior-directed surface, and an aluminum layer adhered to the exterior-directed surface of the intermediate layer. The third layer comprises a sheet.

An adhesive is disposed between both the first layer and the intermediate layer, and the intermediate layer and the third layer.

There is also disclosed a method of manufacturing a flexible composite laminate barrier comprising: (a) providing a first sheet having an exterior-directed surface and an interior-directed surface; (b) depositing a coating on the exterior-directed surface of the first sheet; (c) providing an intermediate sheet having an exterior-directed surface and an interior-directed surface; (d) adhering an aluminum layer to the exterior-directed surface of the intermediate sheet; (e) placing the intermediate sheet next to the first sheet such that the aluminum layer is adjacent the interior-directed surface of the first sheet; (d) placing a third sheet adjacent the interior-directed surface of the intermediate sheet; (f) depositing an adhesive between the first sheet and the intermediate sheet, and between the intermediate sheet and the third sheet; and (g) pressurizing the first sheet, the intermediate sheet, and the third sheet together to form the laminate barrier.

A second method of manufacturing is disclosed which comprises: (a) providing a first sheet having an exterior-directed surface and an interior-directed surface; (b) depositing a coating on the exterior-directed surface of the first sheet; (c) providing an aluminum sheet; (d) depositing a PVC liquid on the aluminum sheet to form an intermediate layer having an exterior-directed surface and an interior-directed surface; (e) placing the intermediate layer next to the first sheet such that the aluminum sheet is adjacent the interior-directed surface of the first sheet; (d) placing a third sheet adjacent the interior-directed surface of the intermediate layer; (f) depositing an adhesive between the first sheet and the intermediate layer, and between the intermediate layer and the third sheet; and (g) pressurizing the first sheet, the intermediate layer, and the third sheet together to form the laminate barrier.

For a more complete understanding of the present invention, reference is made to the following detailed description and accompanying drawings. In the drawing, like reference characters refer to like parts throughout the views in which:

### BRIEF DESCRIPTION OF THE DRAWINGS

FIG. 1 is an exploded side elevation view of a radiant barrier in accordance with the present invention.

For a more complete understanding of the present invention reference is made to the following detailed description.

### DESCRIPTION OF THE PREFERRED EMBODIMENTS

Now, and with reference to the drawing, there is depicted a reflective barrier, denoted generally at 10. The reflective barrier 10 hereof is a laminate structure comprising multiple layers which, when laminated together, form a flexible sheet which can be suspended freely on an interior-room-side of a window, as a window covering, as a roll-up window shade, or the like.

As referenced throughout, the terms “interior” and “exterior” are not only intended to reference those respective sides of the window, but also intended to reference the respective directions pointing toward the exterior of the window or toward the interior from the window. Thus, it is understood that an “exterior-directed” side of any particular layer in the barrier is the side positioned closer toward the exterior and the window, while an “interior-directed” side is the side closer to the interior of the room and away from the window.

With more particularity, the present reflective barrier 10 includes a first layer 12, an intermediate layer 14 and a third layer 16.

For purposes of the present description, the first layer 12 is may be referenced as the exterior-directed layer and the third layer 16 may be referenced as the interior-exposed or interior-directed layer.

As shown in the drawing, the first or exterior layer 12 comprises a non-heat absorbing polyethylene terephthalate (PET) sheet 13. The PET sheet is formed by the transesterification of a terephthalate acid and ethylene glycol. As understood by those having ordinary skill in the art, PET sheets are fibrous sheets which are traditionally referred to as “polyester.”

As known to those skilled in the art, a polyester sheet, or sheeting, is a semi-rigid polyethylene polyester which can be rolled or unrolled, as desired. In accordance herewith, the layer 12 has an exterior-directed side, or surface 20, and an interior-directed side, or surface 21.

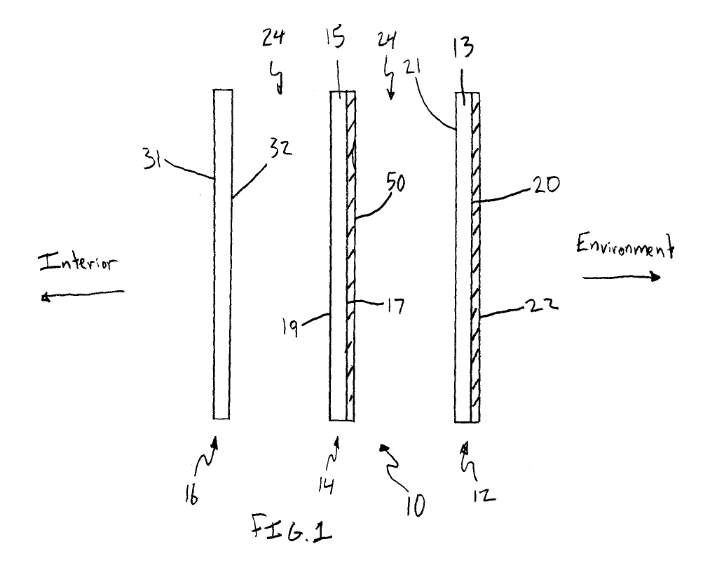

A coating 22 is deposited onto at least the exterior-directed surface 20 of the sheet 13. Although the coating 22 is only shown on the surface 20 in FIG. 1, both the surfaces 20 and 21 may have the coating 22 deposited thereon. The coating 22 may comprise a flat oil-based or water-based white paint such as a primer or the like. Such primers are well known and commercially available. Alternatively, the coating 22 can comprise a film, such as those sold by FLEXcon Company, Inc. under the trademarks COMPUCAL® or COMPUCAL II®.

The coating 22 can be applied to the layer 12 by any suitable means such as by inking, rolling, spraying, immersion, or the like.

Generally, the coating 22 is deposited to a thickness of from about 0.1 to about 0.2 mils on the surfaces 20,21. It is also known that the films sold by FLEXcon have thicknesses of about 1 to about 2 mils.

By applying the coating to the surface 20, the layer 12 is rendered non-heat or non-radiant absorbent to the extent that sunlight may impinge thereupon.

Preferably, the intermediate layer 14 comprises a PVC sheet 15. The PVC sheet 15 has an exterior-directed surface 17 and an opposite interior-directed surface 19. The PVC sheet 15 is manufactured from a PVC resin to which traditional plasticizers and the like have been added to enable the resin to be calendered into a sheet.

The surface 17 has an aluminum layer 50 applied thereto. The layer 50 can be applied by any suitable means, such as by sputter deposition or the like. As is known to the skilled artisan, sputter deposition is also known as physical vapor deposition (PVD) by sputtering. The deposition of the layer 50 is carried out by exposing the sheet surface 17 to an aluminum vapor maintained at a suitable temperature well-known to the skilled artisan. The layer 50 is a thin film layer having a thickness of about 0.48 mil to about 0.5 mil. Although other means of adhering the aluminum layer to the surface 17 may be used, PVD is preferred.

The third or interior layer 16 is substantially the same or is identical to the outer layer 12, having an interior-directed surface 31 and an exterior-directed surface 32. Preferably, the layer 16 is left uncoated and exhibits a “gray” tinge or color.

In assembling the barrier 10, the three layers comprising the first layer 12, the intermediate layer 14, and the third layer 16 are laminated together using a solvent-based acrylic heat-seal adhesive 24. In the drawing, it is noted that the reference numeral “24” generally indicates the locations in which the adhesive 24 is deposited rather than displaying the actual adhesive itself.

The adhesive is preferably an acrylate adhesive. Acrylate adhesives are well known and commercially available. They generally comprise a polymerizable compound such as monoacrylates, diacrylates, triacrylates, urethane-modified acrylates, polyester-modified acrylates and mixtures thereof. Suitable compounds which may be used in the practice of the present invention include, but are not limited to, trimethylolpropane triacrylate 1,6 as hexane diol diacrylate, aliphatic urethane acrylates, vinyl acrylates, epoxy acrylates, methylmethacrylate, ethoxylated bisphenol A diacrylates, trifunctional acrylic ester unsaturated cyclic diones, polyester diacrylates, and mixtures of the above compositions. Ordinarily, these adhesives are methylmethacrylate-based adhesives admixed in a solvent base. These are heat-curable or UV-curable. Such adhesives are well-known and commercially available. The adhesive as noted is applied to the respective surfaces of the PET layers by any suitable made such as spraying, brushing, immersion or the like.

The adhesive 24 is deposited onto the interior-directed surface 21 of the layer 12, the interior-directed surface 19 of the layer 14, the aluminum layer 50, and the exterior-directed surface 32 of layer 16.

The lamination proceeds by pressing the layers 12,14,16 having the adhesive 24 deposited thereon together under suitable heat and pressure as it is processed through a continuous rolling press, such as using calendering rolls.

In an alternate embodiment hereof, the intermediate layer 14 may comprise a PVC-coated aluminum foil. In this embodiment, the PVC is a clear coat liquid which is deposited onto the foil by any suitable means including spraying, dipping, immersion, brushing or the like. Similarly, the foil may be powder-coated with the PVC. The adhesive 24 is then applied over the PVC clear coat. In all other respects, the barrier 10 itself, and the lamination process remain the same.

Although not shown, regardless of the embodiment, after the lamination is completed, the barrier 10 is then perforated by being passed through a mechanical perforator or any other suitable means, such as a laser or the like. Alternatively, the layers 12,14,16 may be perforated prior to lamination. As understood by one having ordinary skill in the art, the perforations are provided to allow partial viewing through the barrier 10.

It is apparent from the proceeding, there has been described herein a reflective barrier which controls the directional flow of thermal heat and radiant energy from the sun.

What is claimed is:

1. A flexible composite laminate barrier for placement near the interior of a window to control the passage of heat therethrough, the barrier comprising a first exterior-directed layer, an intermediate layer, and a third interior-directed layer in which:
(a) the first layer comprises a sheet having an exterior-directed surface and an interior-directed surface, and a coating disposed on the exterior-directed surface of the sheet;
(b) the intermediate layer comprises a sheet having an exterior-directed surface and an interior-directed surface, and an aluminum layer adhered to the exterior-directed surface of the intermediate layer;
(c) the third layer comprises a sheet; and
(d) an adhesive disposed between both the first layer and the intermediate layer, and the intermediate layer and the third layer.

2. The laminate barrier of claim 1 wherein the first sheet of the first layer comprises PET.

3. The laminate barrier of claim 1 wherein the coating is non-transparent.

4. The laminate barrier of claim 1 wherein the coating is additionally disposed on the interior-directed surface of the sheet in the first layer.

5. The laminate barrier of claim 1 wherein the sheet in the intermediate layer comprises PVC.

6. The laminate barrier of claim 2 wherein the sheet in the intermediate layer comprises PVC.

7. The laminate barrier of claim 1 wherein the aluminum layer is deposited onto the sheet in the intermediate layer using a sputter deposition process.

8. The laminate barrier of claim 1 wherein the aluminum layer is a foil.

9. The laminate barrier of claim 1 wherein the adhesive is a solvent-based acrylic heat-seal.

10. The laminate barrier of claim 2 wherein the adhesive is a solvent-based acrylic heat-seal.

11. The laminate barrier of claim 1 wherein the adhesive is an acrylate adhesive.

12. A method of manufacturing a flexible composite laminate barrier comprising:
(a) providing a first sheet having an exterior-directed surface and an interior-directed surface;
(b) depositing a coating on the exterior-directed surface of the first sheet;
(c) providing an intermediate sheet having an exterior-directed surface and an interior-directed surface;
(d) adhering an aluminum layer to the exterior-directed surface of the intermediate sheet;
(e) placing the intermediate sheet next to the first sheet such that the aluminum layer is adjacent the interior-directed surface of the first sheet;
(d) placing a third sheet adjacent the interior-directed surface of the intermediate sheet;
(f) depositing an adhesive between the first sheet and the intermediate sheet, and between the intermediate sheet and the third sheet; and
(g) pressurizing the first sheet, the intermediate sheet, and the third sheet together to form the laminate barrier.

13. The method of claim 12 wherein the aluminum layer is adhered to the intermediate sheet using sputter deposition.

14. The method of claim 12 wherein the adhesive is an acrylic.

15. The method of claim 12 including the step of heating the first sheet, the intermediate sheet, and the third sheet together to form the laminate barrier.

16. The method of claim 12 wherein the first sheet, the intermediate sheet, and the third sheet are calendered together to form the laminate barrier.

17. A method of manufacturing a flexible composite laminate barrier comprising:
(a) providing a first sheet having an exterior-directed surface and an interior-directed surface;
(b) depositing a coating on the exterior-directed surface of the first sheet;
(c) providing an aluminum sheet;
(d) depositing a PVC liquid on the aluminum sheet to form an intermediate layer having an exterior-directed surface and an interior-directed surface;
(e) placing the intermediate layer next to the first sheet such that the aluminum sheet is adjacent the interior-directed surface of the first sheet;
(d) placing a third sheet adjacent the interior-directed surface of the intermediate layer;
(f) depositing an adhesive between the first sheet and the intermediate layer, and between the intermediate layer and the third sheet; and
(g) pressurizing the first sheet, the intermediate layer, and the third sheet together to form the laminate barrier.

18. The method of claim 17 wherein the adhesive is an acrylic.

19. The method of claim 17 including the step of heating the first sheet, the intermediate sheet, and the third sheet together to form the laminate barrier.

20. The method of claim 17 wherein the first sheet, the intermediate sheet, and the third sheet are calendered together to form the laminate barrier.
